(19) United States
(12) Patent Application Publication
(10) Pub. No.: US 2014/0226683 A1
(43) Pub. Date: Aug. 14, 2014

(54) NETWORK ADAPTER WITH HIGH PERFORMANCE IN-LINE TIMESTAMP

(71) Applicant: SILICOM LTD., Kfar Saba (IL)

(72) Inventor: David Castiel, Even-Yehuda (IL)

(73) Assignee: SILICOM LTD., Kfar Saba (IL)

(21) Appl. No.: 13/766,796

(22) Filed: Feb. 14, 2013

(51) Int. Cl. H04L 12/24

(52) U.S. Cl. CPC H04L 41/00
USPC 370/474

(57) ABSTRACT

A method, including receiving, at a first time of receipt, a first data frame and incorporating a first timestamp having a first length into the first data frame, the first timestamp being indicative of the first time of receipt. The method further includes subsequent to the first time of receipt, sequentially receiving at respective second times second data frames. The method continues by incorporating respective second timestamps having second lengths shorter than the first length into the second data frames, the respective second timestamps being indicative of respective increments in time from the first time of receipt.

### FIELD OF THE INVENTION

The present invention relates generally to data packet reception, and specifically to timing of the packets.

### BACKGROUND OF THE INVENTION

As the volume of data communications continues to expand, there are certain segments of the communications where it is important to know a time of receipt of a data packet or frame.

U.S. Patent Application 2011/0149998 to Thompson, whose disclosure is incorporated herein by reference, describes a system for timestamping a data frame. The disclosure refers to a data frame that includes a type field and data for receipt by a communication network. The disclosure states that if the value of the type field indicates the data frame is a time-stamped frame, a timestamp field is inserted in the data frame. The timestamp field indicates the reception time.

European Patent EP1771997 to Steindl, whose disclosure is incorporated herein by reference, describes a system for stamping Ethernet frames with a timestamp. The stamp is stated to be stored in the area of the media access control (MAC) destination address, and an original MAC destination address is stated to be encoded in a remaining area of a frame.

Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

### SUMMARY

An embodiment of the present invention provides a method, including:

receiving, at a first time of receipt, a first data frame;

incorporating a first timestamp having a first length into the first data frame, the first timestamp being indicative of the first time of receipt;

subsequent to the first time of receipt, sequentially receiving at respective second times second data frames;

incorporating respective second timestamps having second lengths shorter than the first length into the second data frames, the respective second timestamps being indicative of respective increments in time from the first time of receipt.

Typically, the first data frame received and the second data frames received comply with an Ethernet protocol.

The method may further include, subsequent to the respective second times, receiving a third data frame at a third time of receipt, and incorporating a third timestamp having the first length into the third data frame, the third timestamp being indicative of the third time of receipt. In a disclosed embodiment receiving the third data frame is in response to a counter of the respective increments overflowing.

In an alternative embodiment the first timestamp and the second timestamps include an indication of one of the first length and the second length.

In a further disclosed embodiment the first length is 9 bytes, and the second lengths are 5 bytes.

In a further alternative embodiment, incorporating the first timestamp includes appending the first timestamp to a first payload of the first data frame, and incorporating the respective second timestamps includes appending the second timestamps to respective second payloads of the second data frames.

In a yet further alternative embodiment the first data frame includes a first error checksum, and incorporating the first timestamp includes replacing the first error checksum by the first timestamp, and the second data frames include respective second error checksums, and incorporating the respective second timestamps includes replacing the second error checksums by the respective second timestamps.

There is further provided, according to an embodiment of the present invention embodiment of the present invention, a method, including:

receiving at a receipt time a data frame having an error checksum;

generating a timestamp indicative of the receipt time; and

incorporating the timestamp into the data frame in place of the error checksum.

The method may also include:

receiving at a time subsequent to the receipt time a further data frame including a further error checksum;

generating a further timestamp indicative of an increment from the subsequent time to the receipt time; and

incorporating the further timestamp into the further data frame in place of the further error checksum.

In a disclosed embodiment the further timestamp is shorter than the timestamp. The timestamp and the further timestamp may respectively include an indication of a length of the timestamp and the further timestamp.

The method may further include:

receiving at respective times subsequent to the receipt time respective further data frames including further error checksums;

generating respective further timestamps indicative of the respective subsequent times; and

incorporating the respective further timestamps into the respective further data frames in place of the further error checksums.

There is further provided, according to an embodiment of the present invention, apparatus, including:

a processor which is configured to receive, at a first time of receipt, a first data frame, and subsequent to the first time of receipt, sequentially to receive at respective second times second data frames; and

a timestamp engine which is configured to:

incorporate a first timestamp having a first length into the first data frame, the first timestamp being indicative of the first time of receipt, and

incorporate respective second timestamps having second lengths shorter than the first length into the second data frames, the respective second timestamps being indicative of respective increments in time from the first time of receipt.

The present invention will be more fully understood from the following detailed description of the embodiments thereof, taken together with the drawings in which:

### BRIEF DESCRIPTION OF THE DRAWINGS

FIG. 1 is a schematic block diagram of a network adapter, according to an embodiment of the present invention;

FIG. 2 illustrates schematic formats for different data frames of the adapter, according to an embodiment of the present invention;

FIG. 3 is a schematic block diagram of a timestamp engine, according to an embodiment of the present invention; and

FIG. 4 is a flowchart of steps followed in operation of the timestamp engine, according to an embodiment of the present invention.

### DETAILED DESCRIPTION OF EMBODIMENTS

### Overview

An embodiment of the present invention provides a method for timestamping data frames, typically data frames that are transmitted according to an Ethernet protocol. The method is typically implemented by a timestamp engine that is incorporated into a network adapter that receives and transmits the data frames. The timestamps are typically appended to the payloads of the frames. In some embodiments the appended timestamps replace an error checksum of the frames. In other embodiments the frames include an error checksum.

The timestamp is formulated in two formats: a first format that indicates a complete time of receipt of a specific data frame, and a second format that provides an increment in time from the complete time of receipt of the specific data frame. Once the specific data frame has been received and timestamped with the complete time of receipt, only increments in time are used for timestamping frames received subsequent to the specific frame. Typically, the method configures specific frames, wherein the timestamp gives a complete time of receipt, to occur once a second, so that the incremental timestamps of the subsequent frames are for fractions of a second.

The incremental timestamps are shorter than the timestamps having the complete time of receipt. Consequently, in a series of data frames the overhead, or penalty, incurred by timestamping the data frames is significantly less than would be incurred if every data frame is stamped with a complete time of receipt. The overall reduction in overhead, compared to other timestamping systems known in the art, and the corresponding improvement in efficiency of data transfer applies to all data frames that are stamped. For frames carrying small payloads, and that are formatted according to an Ethernet protocol, the improvement is greater than 2%.

### System Description

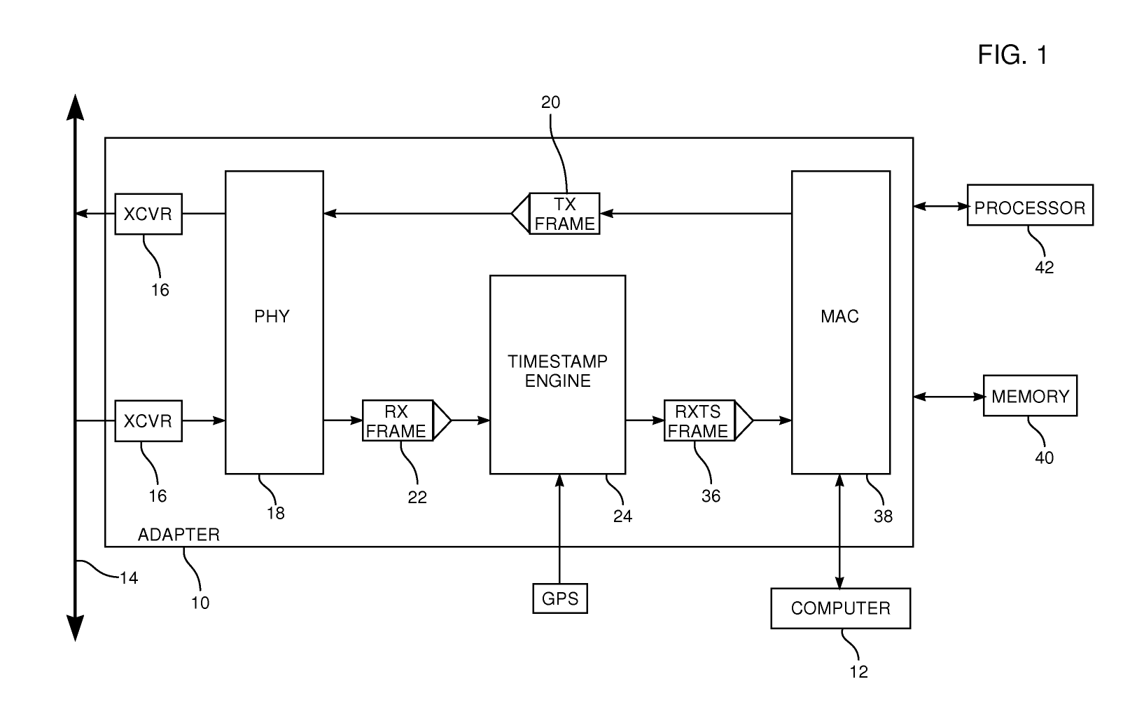

Reference is now made to FIG. 1, which is a schematic block diagram of a network adapter 10, according to an embodiment of the present invention. Adapter 10 is typically implemented with elements of the adapter incorporated into a printed circuit board which is connected to a computer 12. However, it will be understood that this implementation is by way of example, and other implementations, such as having the elements of the adapter implemented in a distributed format and/or as an Application Specific Integrated Circuit (ASIC), will be apparent to those having ordinary skill in the art.

Adapter 10 couples computer 12 to a transmission medium 14, and facilitates transmission of data between the medium and the computer. In the following description medium 14 is assumed to comprise fiber optic cabling, so that signals representing the data are assumed to be conveyed between adapter 10 and medium 14 using optical transceivers 16. (Transceivers 16 are typically SFP (small form-factor pluggable) transceivers.) However, embodiments of the present invention may be used for any data transmission medium known in the art, including vacuum, air, and conductors such as copper cabling.

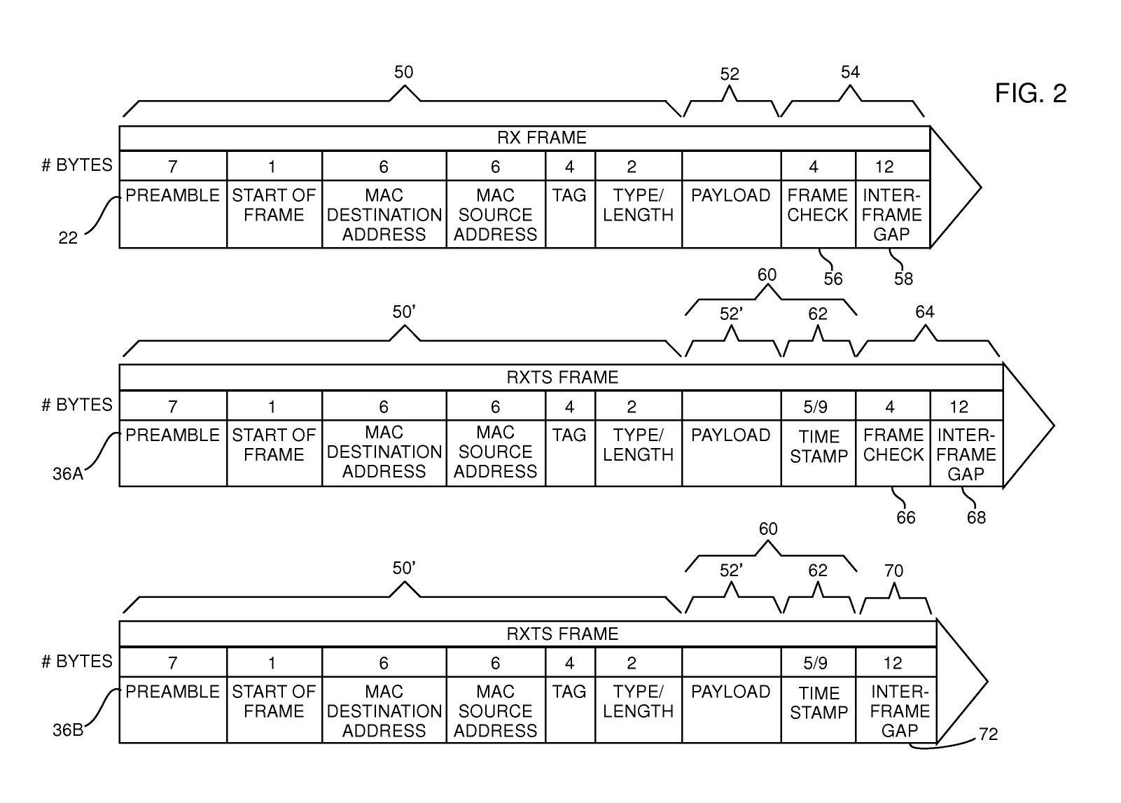

Data in the form of data packets is conveyed within medium 14, and in the disclosure the packets within the medium are assumed to comply with an Ethernet protocol, as defined by the IEEE Computer Society, Washington, D.C., that encapsulates payload data as Ethernet frames. An exemplary format for such an Ethernet frame is described with reference to FIG. 2 below. In addition, data transferred within adapter 10 is also transferred in the form of Ethernet frames. Data within medium 14 is assumed to be conveyed in serial form at rates of 10 Gbits/s, although embodiments of the present invention may be operated at rates above or below this rate.

A physical layer (PHY) device 18 is used by adapter 10 to transmit Ethernet frames 20, having data payloads generated by computer 12, into medium 14. Transmitted frames 20 are also referred to herein as TX frames 20. Device 18 is also used to receive Ethernet frames 22, addressed to computer 12, from medium 14. Received frames 22 are also referred to herein as RX frames 22. In one embodiment device 18 comprises a VSC8488-15 serial—parallel transceiver, produced by Vitesse Semiconductor Corporation, Camarillo, Calif., which converts between serial data suitable for medium 14 and data in a parallel format. The parallel format, herein assumed to be used for transfer of frames within adapter 10, is assumed by way of example to be according to an XAUI (10 Gbit Attachment User Interface) standard, published by the IEEE Standards Association, Piscataway, N.J. However, it will be appreciated that adapter 10 may be implemented to transfer frames according to substantially any data frame standard known in the art, such as, but not limited to, an XFI (10 Gbit Small Form Factor Interface) standard, and those having ordinary skill in the art will be able to adapt the description for such other standards.

PHY device 18 is coupled to a timestamp engine 24, which in a disclosed embodiment is implemented as a field programmable gate array (FPGA). Engine 24 operates to incorporate timestamps into received RX frames 22. Thus, for each RX frame 22 the engine generates a corresponding “received-frame-with-timestamp” 36, also referred to herein as an RXTS-frame 36, which is conveyed to a media access control (MAC) 38. The formation of RXTS-frames 36 from RX-frames 22 is described in detail below. Embodiments of the present invention provide different formats for RXTS-frames 36, and in the disclosure the formats are differentiated, as necessary, by appending a letter to the numerical identifier 36 of the RXTS-frames, for example as RXTS-frame 36A and RXTS-frame 36B. Absent an appended letter, reference to RXTS-frames 36 or to RXTS-frame 36 is to be understood as referring to a generic received-frame-with-timestamp in any of the different formats.

MAC 38 generates TX-frames 20 by encapsulating payload data received from computer 12 according to the Ethernet protocol operating in medium 14. The encapsulation includes, inter alia, adding a MAC address of MAC 38 as a source address, as well as adding a MAC address of the destination for the payload data.

MAC 38 also receives RXTS-frames 36 from engine 24, the RXTS-frames including payload data, for computer 12, which is also encapsulated according to the Ethernet protocol referred to above. The encapsulation of the RXTS-frames includes the timestamp that has been inserted into the frames by engine 24. The encapsulation for the RXTS-frames may also include the MAC address of MAC 38 as a destination address, as well as a MAC address of the payload source. MAC 38 is configured to remove the encapsulation from the RXTS-frames, and to store components of the encapsulation, e.g., the timestamp of the frames and the source MAC addresses, in a memory, such as a memory 40, which is accessible to computer 12. Using the timestamp stored in memory 40, computer 12 may thus determine the time of arrival of each RX-frame 22 received by adapter 10.

At least some of the elements, described above, of adapter 10 may comprise a processor which provides overall control for operations of the adapter. For example, MAC 38 may comprise a processor, and/or functions of a processor may be distributed amongst elements of the adapter. Alternatively, overall control of adapter 10 may be provided by a processor within computer 12. For simplicity in the following description adapter 10 is assumed to comprise a separate processor 42; however those having ordinary skill in the art will be able to adapt the description for other types of processor, such as those described above, and where this processor is used to provide overall control of adapter operations.

FIG. 2 illustrates schematic formats for an RX-frame 22, an RXTS-frame 36A, and an RXTS-frame 36B, according to an embodiment of the present invention. As shown for RX-frame 22, the frame has a precursor set of fields 50, comprising a 7 byte preamble, a 1 byte start of frame delimiter, a 6 byte MAC destination address, a 6 byte MAC source address, a 4-byte optional tag, used if an IEEE 802.1Q networking standard is implemented, and a 2 byte Ethertype or length field. The precursor set of fields is followed by a payload field 52. The length of the payload field depends on the payload populating the field, and on the particular Ethernet protocol being used, and may vary from 42 bytes to approximately 9000 bytes.

RX-frame 22 concludes with successor set of fields 54. Set of fields 54 comprises a 4 byte frame check field 56, typically filled with a cyclic redundancy check (CRC) or an error checksum, set of bytes that are used to check for errors in RX-frame 22. For simplicity, in the following description, the data filling frame check field or other frame check fields is referred to as the error checksum data or just as the error checksum. Frame check field 56 is followed by a 12 byte or more interframe gap field 58.

RXTS-frame 36A has a generally similar structure to the structure of the RX-frame. Thus RXTS-frame 36A has a precursor set of fields which typically comprises the same elements, having the same values, as precursor set 50, so that the RXTS-frame precursor set of fields has an identifier 50′. In RXTS-frame 36A precursor set 50′ is followed by an augmented payload field 60. Augmented payload field 60 comprises a payload field 52′, having the same value as payload field 52 of the RX-frame, together with a timestamp field 62 which follows payload field 52′. In embodiments of the present invention, adapter 10 is configured to operate RXTS-frames that may have larger payloads than those permitted by the protocol used to form the corresponding RX-frames.

RXTS-frame 36A concludes with a successor set of fields 64, comprising a frame check field 66 followed by an interframe gap field 68. Values entered in frame check field 66 of RXTS-frame 36A are typically different from the values present in the frame check field of RX-frame 22, as is explained below.

As shown for RXTS-frame 36B, the frame has a generally similar structure to the structure of RXTS-frame 36A, having a precursor set of fields 50′ and an augmented payload field 60. As for RXTS-frame 36A, augmented payload field 56 in RXTS-frame 36B comprises payload field 52′ and timestamp field 62. However, in RXTS-frame 36B there is no frame check field in a successor set of fields 70. Rather, successor set of fields 70 comprises only an interframe gap field 72.

Comparing the structure of RX-frame 22 with that of RXTS-frame 36B, it is seen that timestamp field 62 effectively replaces frame check field 56 of RX-frame 22.

Derivation of the value inserted into timestamp field 62, as well as of the values of elements of frame check field 66 in successor set of fields 64, is described in more detail below.

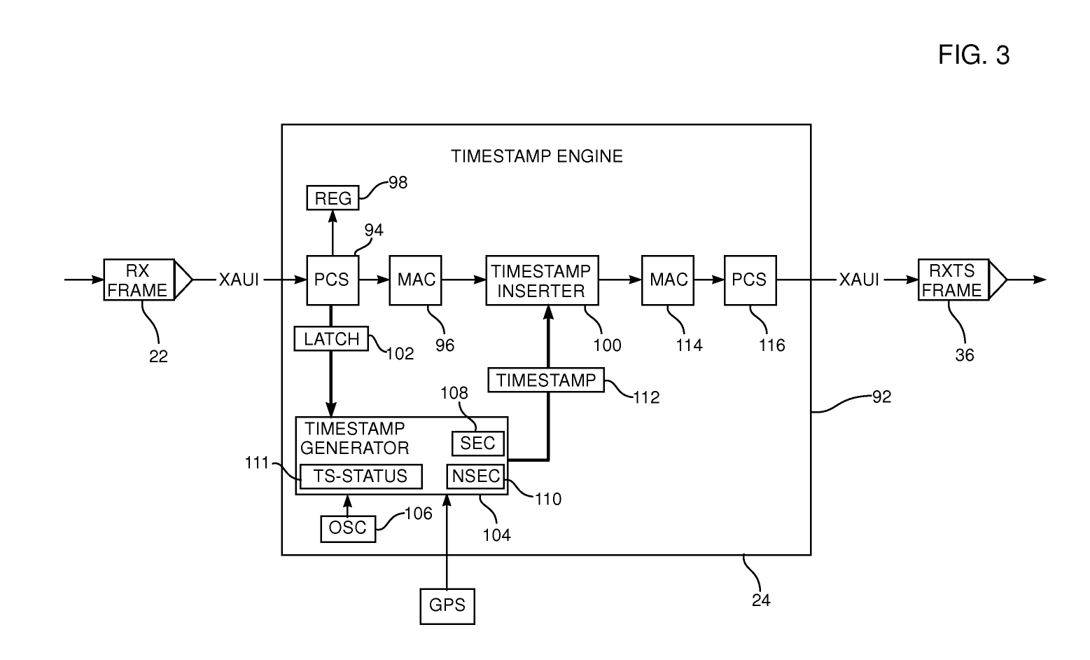

FIG. 3 is a schematic block diagram of timestamp engine 24, according to an embodiment of the present invention.

Each RX-frame 22 is received by engine 24 according to the XAUI standard, and the frame is processed in a receive-frame channel 92. On receipt, the data in set 50 of the precursor fields of the RX-frame (FIG. 2), comprising a frame preamble, start of frame delimiter, MAC source and destination addresses, a tag field, and a type/length field, is removed in a physical coding sublayer (PCS) device 94 and a MAC device 96. Devices 94 and 96 are also configured to remove successor fields 54. The data removed by devices 94 and 96 is stored in a register 98, and the remaining frame data, comprising payload data from payload data field 52, is transferred to a timestamp inserter device 100.

In addition, as device 94 receives an RX-frame, it provides a latching signal 102 to a timestamp generator 104. Generator 104 is typically configured to receive an external timing signal once a second, which the generator uses to provide an initial value of a current time when adapter 10 begins operation, as well as to update a seconds SEC counter 108. The initial value of the current time is stored in seconds SEC counter 108 and in a nanoseconds NSEC counter 110. The timing signal received by generator 104 is typically synchronized to a GPS (global positioning system) signal, or by a signal generated according to a PTP (Precision Time Protocol) such as that defined by an IEEE 1588 standard, or by any other timing signal known in the art.

Alternatively, the timing signal providing the updates to SEC counter 108 may be generated using an internal oscillator of engine 24, such as an OSC 106 described below. In this case no external timing signal is required, and a current time initial value may be derived from a clock that is set by an operator of adapter 10.

For simplicity, in the disclosure the received timing signal is assumed to correspond to a GPS signal, and those having ordinary skill in the art will be able to adapt the description for other received timing signals, such as a PTP signal.

Generator 104 is synchronized by phase-locked loop (PLL) oscillator OSC 106, which acts as a low noise precision clock for the generator, enabling the generator to update the values stored in SEC counter 108 and NSEC counter 110 so as to reflect a current time. The process for updating is described in more detail below.

In the following description, by way of example, SEC counter 108 is assumed to comprise a 4 byte register, wherein each bit represents 1 s, so that the seconds counter is able to count up to 0xFFFFFFFF seconds, which corresponds to more than 136 years.

Also on a continuing basis, generator 104 uses the clock signal from OSC 106 to update a nanosecond NSEC counter 110. In the following description, by way of example, NSEC counter 110 is assumed to comprise a 4 byte register, wherein each bit represents 1 ns. Counter 110 is configured to count up to 0x3B9AC9FF nanoseconds, corresponding to 999,999,999 ns, before overflowing and starting to count from 0. In other words, counter 110 overflows once per second. If no external timing signal is used, then at each overflow of NSEC counter 110, SEC counter 108 increments by 1. Alternatively, for the case where an external timing signal is received, as each second signal is received SEC counter 108 increments by 1, and NSEC counter 110 restarts counting from 0.

In addition to SEC counter 108 and NSEC counter 110, generator 104 also comprises a timestamp control register which stores a status 111, herein also referred to as TS-STATUS 111, of a timestamp 112 formed by the generator. TS-STATUS 111 is herein assumed, by way of example, to be 1 byte in size. Functions of TS-STATUS 111 comprise:

Providing an indication if the error checksum of the RX-frame 22 is valid or invalid;

Providing an indication of the length of the time values comprised in timestamp 112; and

Providing a signature used to identify the status byte.

On receipt of latching signal 102 generator 104 forms timestamp 112. As described in more detail below, timestamp 112 is in two forms: a first form that comprises only values derived from NSEC counter 110, and a second form that comprises values derived both from NSEC counter 110 and from SEC counter 108. In the first form the timestamp comprises increments in time; in the second form the timestamp comprises a complete time of receipt of a frame. TS-STATUS 111 indicates which of the two forms (i.e., only NSEC, or SEC+NSEC) are included in timestamp 112, and TS-STATUS 111 is included in timestamp 112.

Timestamp 112 is transferred to timestamp inserter 100. As stated above, inserter 100 also receives payload data, herein termed original payload data, that is in payload data field 52 (FIG. 2). Timestamp inserter 100 inserts the original payload data into payload data field 52′, and timestamp 112 into timestamp field 62, i.e., after the payload, to populate augmented payload field 60 with an augmented payload.

Engine 24 uses a MAC device 114 and a PCS device 116 to generate values for elements of set of precursor fields 50′, typically by reading appropriate values from register 98, as well as to apply the values in forming RXTS-frame 36, as is described in more detail below. PCS device 116 then transmits an assembled RXTS-frame 36 to MAC 38.

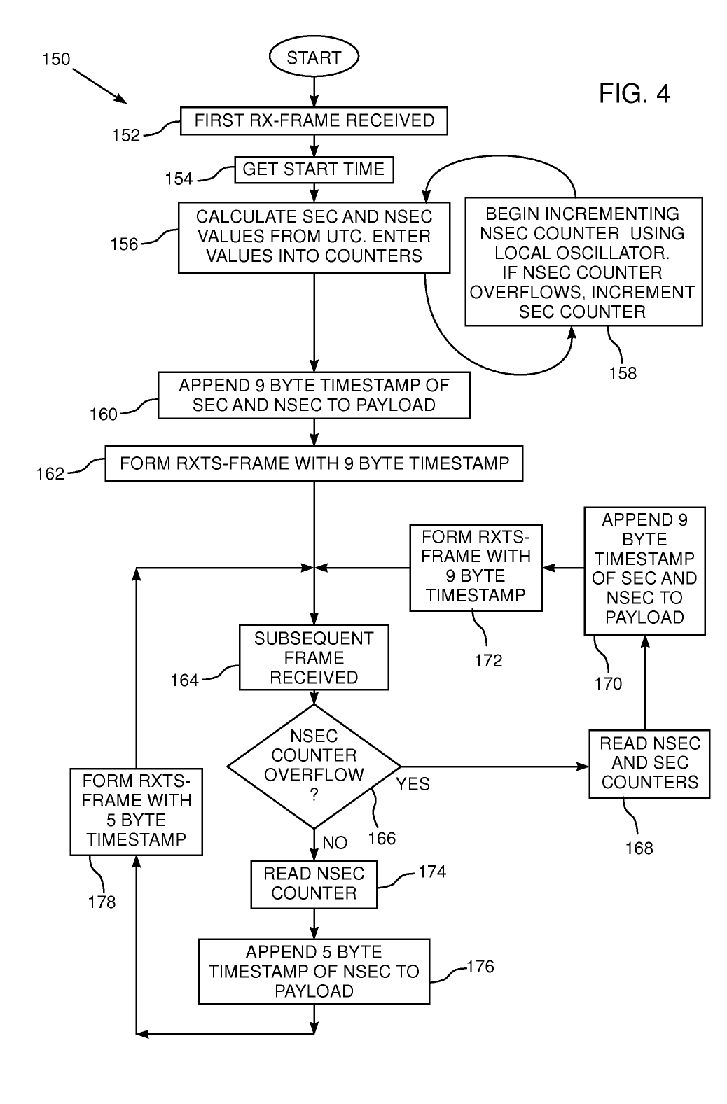

FIG. 4 is a flowchart 150 of steps followed in operation of timestamp engine 24, according to an embodiment of the present invention. The steps may be implemented under overall control of processor 42, and/or by individual elements of adapter 10. Flowchart 150 describes the steps taken by the engine in operating on a series of frames received from transmission medium 14 as the received frames transfer through receive-frame channel 92 (FIG. 3).

For simplicity, the description of the steps of the flowchart assumes that an external GPS signal is available to engine 24. Those having ordinary skill in the art will be able to adapt the description, mutatis mutandis for cases where no external timing signal is used by the engine.

In an initial step 152, PHY device 18 transfers a first received frame RX-frame 22 to PCS 94. On receipt of the frame, PCS 94 conveys latching signal 102 to generator 104. In addition, PCS 94 and MAC 96 store data read from precursor fields 50 and successor fields 54 in register 98, transfer original payload data from payload field 52 to timestamp inserter 100, and record whether the error checksum in frame check field 56 is valid or invalid.

In a get start time step 154, on receipt of the latching signal, generator 104 formulates a value of an initial time. Using processor 42, the generator synchronizes to the GPS time signal in order to formulate the initial time. The time signal provides the current time in a UTC (Coordinated Universal Time) format.

In a conversion step 156, generator 104 calculates a value of the current time, typically, in the case of the external GPS signal, measured from a UTC base time of YYYY:MM:DD:hh:mm:ss.s=1970:01:01:00:00:00.0, in terms of seconds and parts of a second. In the expression for the current time “ss” corresponds to a whole number of seconds, and “s” corresponds to a decimal part of a second.

For example, if the current time is YYYY:MM:DD:hh:mm:ss.s=2011:11:23:19:45:50.2001, then the whole number of seconds from the base time is calculated for YYYY:MM:DD:hh:mm:ss=2011:11:23:19:45:50, i.e., 41 years, 327 days, 19 hours, 45 minutes, and 50 seconds. This, ignoring leap years, corresponds to 1,321,299,950 s, or 0x4EC16FEE s. In this example, the decimal part of the seconds is 0.2001 seconds which corresponds to 200,100,000 ns, or 0xBED48A0 ns.

The whole number of seconds is entered into SEC counter 108, and the number of nanoseconds is entered into NSEC counter 110.

As shown by a nanosecond increment step 158, on entry of the number of nanoseconds into NSEC counter 110, the NSEC counter begins incrementing, using local oscillator OSC 106 to generate the increments. The value of the increments may be derived from the frequency of OSC 106. For instance, if OSC 106 has a frequency of 25 MHz, corresponding to a period of 40 ns, then the increments may be 40 ns, or a simple divisor of 40 ns such as 20 ns or 10 ns. Alternatively, the value of the increments may be any other suitable number of nanoseconds that may be derived from OSC 106. In one embodiment OSC 106 has a frequency of 25 MHz, and the clock cycles from the oscillator are divided by five, providing increments of 8 ns.

While incrementing NSEC counter 110, timestamp generator 104 checks if the counter has overflowed. In the event of the NSEC counter overflowing, the generator increments SEC counter 108 by 1, while continuing to increment the NSEC counter.

In a payload append step 160, generator 104 assembles a timestamp comprising the values entered into the SEC and NSEC counters in step 156, for a total of eight bytes. The eight bytes provide a complete time of receipt of the frame. TS-STATUS 111 is added to the values of the SEC and NSEC counters, so that the assembled timestamp, corresponding to timestamp 112 (FIG. 3), comprises 9 bytes. In timestamp 112, TS-STATUS 111 is set to indicate that the length of the timestamp is 9 bytes. TS-STATUS 111 is also set to indicate if the error checksum of RX-frame 22 is valid or invalid, as recorded in step 152.

As illustrated in FIG. 3, timestamp 112 is passed to timestamp inserter 100.

In a frame formation step 162, RXTS-frame 36 is generated. As stated above, RXTS-frame 36 may be in a number of different formats. The following description is for generation of the formats illustrated for RXTS-frame 36A and RXTS-frame 36B in FIG. 2.

In the case of RXTS-frame 36A, timestamp inserter 100, MAC device 114, and PCS device 116 assemble the RXTS-frame with precursor fields 50′ having values retrieved from register 98. Precursor fields 50′ are followed by augmented payload field 60. Augmented payload field 60 is populated by original payload data in payload field 52′, to which is appended timestamp 112 data of 9 bytes in timestamp field 62.

Using the data of precursor fields 50′ and augmented payload field 60, MAC device 114 calculates an error checksum for RXTS-frame 36A, and fills frame check field 66 with the error checksum. It will be understood that the error checksum in frame check field 66 is different from the error checksum in RX-frame 22, because the latter has a payload of original payload data whereas RXTS-frame 36A has a payload of augmented payload data.

To complete the formation of RXTS-frame 36A, PCS device 116 adds data for interframe gap field 68, and the device conveys the completed frame to MAC 38.

In the case of RXTS-frame 36B, data for precursor fields 50′ and augmented payload field 60 are inserted into the fields generally as described above for RXTS-frame 36A. In contrast to RXTS-frame 36A, RXTS-frame 36B does not have a frame check field, and MAC device 114 does not calculate an error checksum for the frame. Rather, PCS device 116 completes the frame by adding data for interframe gap field 70; the PCS device then forwards completed RXTS-frame 36B, without any error checksum inserted into the frame, to MAC 38. To allow for the nonappearance of an error checksum in RXTS-frame 36B, MAC 38 and computer 12 are configured to ignore any checksum absence.

In a further frame receipt step 164, PHY device 18 transfers a subsequent RX-frame 22 to PCS 94, and PCS 94 and MAC 96 perform substantially the same operations on the subsequent received frame as are described for step 152.

In a decision step 166, generator 104 checks if NSEC counter 110 has overflowed, as described in step 158 above. If the counter has overflowed, the flowchart proceeds to a read counters step 168, wherein the generator reads SEC counter 108 and NSEC counter 110.

Using the SEC and NSEC values found in step 168, the generator continues to a payload append step 170 and a frame formation step 172. Actions performed in payload append step 170 and frame formation step 172 are respectively substantially the same as those described above for payload append step 160 and frame formation step 162.

If in decision step 166 the NSEC counter has not overflowed, the flowchart proceeds to a read counter step 174, wherein processor 42 only reads NSEC counter 110.

In a payload append step 176, generator 104 assembles a timestamp corresponding to timestamp 112, generally as described above for payload append step 160. However, in contrast to step 160, in step 176 timestamp 112 comprises only 5 bytes, i.e., 4 bytes for the value of NSEC plus 1 byte for TS-STATUS 111. Also, TS-STATUS 111 is set to indicate that the length of timestamp 112 is 5 bytes. The flowchart then proceeds to a frame formation step 178, wherein an RXTS-frame 36 is generated.

Actions in frame formation step 178 are generally similar to those of frame formation step 162 except that bytes are added, and as stated in the description therein, RXTS-frame 36 may be in a number of different formats, exemplified by RXTS-frame 36A and RXTS-frame 36B.

As for the RXTS-frame 36A produced in step 162, the error checksum formed in step 178 for frame check field 66 is different from the error checksum in RX-frame 22, because of the 5 byte timestamp addition.

Similarly, as for the RXTS-frame 36B produced in step 162, to allow for the nonappearance of an error checksum in the RXTS-frame 36B produced in step 178, MAC 38 and computer 12 are configured to ignore any checksum absence.

It will be understood that flowchart 150 illustrates two iterative processes: a first process comprising steps 164, 166, 174, 176, and 178, and a second process comprising steps 164, 166, 168, 170, and 172. The first process occurs when NSEC counter 110 does not overflow, and during this process the 5 byte timestamps are increments of time. The second process occurs when the NSEC counter does overflow, and during this process the 9 byte timestamps provide a complete time of receipt of the relevant data frame.

The description above provides as examples two types of RXTS-frames 36: RXTS-frames 36A and RXTS-frames 36B. Typically, adapter 10 is configured so that in operation it generates either RXTS-frames 36A or RXTS-frames 36B.

The description above has assumed that SEC counter 108 is incremented once per second, and that NSEC counter 110 counts nanoseconds up to the incremental step of the SEC counter (one second), at which point it overflows. It will be understood that the incremental step of the SEC counter is by way of example, and that other embodiments of the present invention may use larger or smaller values of an incremental step for the SEC counter. Similarly, NSEC counter 110 may be configured to count sub-units of seconds other than nanoseconds, such as microseconds, and/or may be configured to overflow according to an incremental step of the SEC counter that is different from once per second.

It will also be understood that the sizes specified for timestamp 112, of 5 bytes or 9 bytes, are by way of example, and that other embodiments of the present invention may use different sizes, and that the sizes may not necessarily be whole numbers of bytes. For example, SEC counter 108, NSEC counter 110, and/or TS-STATUS 111 may be configured to have fractional numbers of bytes, so typically changing the number of bytes in timestamp 112 from the 5 bytes and 9 bytes sizes exemplified above.

Alternatively or additionally, the configuration of the values generated by SEC counter 108 and/or NSEC counter 110, and inserted, together with TS-STATUS 111 into timestamp field 62, may be different from the configurations described above.

As a first disclosed example, SEC counter 108 uses 5 bits, and NSEC counter uses 27 bits, so that the timestamp inserted into field 62 comprises 4 bytes (32 bits). In this case each least significant bit of the NSEC counter may be set to correspond to a period of 8 ns, so that the timestamp has a resolution of 8 ns.

As second disclosed example, SEC counter 108 may be configured to use 1 byte (8 bits), and NSEC counter 110 may use 3 bytes. In this case each least significant bit of the NSEC counter may be set to correspond to a period of 64 ns.

It will be understood that the two above disclosed examples describe timestamps of a constant length of 5 bytes, rather than varying length timestamps. Such a constant length timestamp may typically be used advantageously in RXTS-frame 36B wherein there is no error checksum. A constant length timestamp, such as is described in the two above examples, may also be used in RXTS-frame 36A. It will also be understood that since these constant length timestamps comprise both second and nanosecond values, the timestamps provide a complete time of receipt of a frame.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
receiving, at a first time of receipt, a first data frame;
incorporating a first timestamp having a first length into the first data frame, the first timestamp being indicative of the first time of receipt;
subsequent to the first time of receipt, sequentially receiving at respective second times second data frames;
incorporating respective second timestamps having second lengths shorter than the first length into the second data frames, the respective second timestamps being indicative of respective increments in time from the first time of receipt.

2. The method according to claim 1, wherein the first data frame received and the second data frames received comply with an Ethernet protocol.

3. The method according to claim 1, and further comprising, subsequent to the respective second times, receiving a third data frame at a third time of receipt, and incorporating a third timestamp having the first length into the third data frame, the third timestamp being indicative of the third time of receipt.

4. The method according to claim 3, wherein receiving the third data frame is in response to a counter of the respective increments overflowing.

5. The method according to claim 1, wherein the first timestamp and the second timestamps comprise an indication of one of the first length and the second length.

6. The method according to claim 1, wherein the first length is 9 bytes, and wherein the second lengths are 5 bytes.

7. The method according to claim 1, wherein incorporating the first timestamp comprises appending the first timestamp to a first payload of the first data frame, and wherein incorporating the respective second timestamps comprises appending the second timestamps to respective second payloads of the second data frames.

8. The method according to claim 1, wherein the first data frame comprises a first error checksum, and wherein incorporating the first timestamp comprises replacing the first error checksum by the first timestamp, and wherein the second data frames comprise respective second error checksums, and wherein incorporating the respective second timestamps comprises replacing the second error checksums by the respective second timestamps.

9. A method, comprising:
receiving at a receipt time a data frame comprising an error checksum;
generating a timestamp indicative of the receipt time; and
incorporating the timestamp into the data frame in place of the error checksum.

10. The method according to claim 9, and comprising:
receiving at a time subsequent to the receipt time a further data frame comprising a further error checksum;
generating a further timestamp indicative of an increment from the subsequent time to the receipt time; and
incorporating the further timestamp into the further data frame in place of the further error checksum.

11. The method according to claim 10, wherein the further timestamp is shorter than the timestamp.

12. The method according to claim 10, wherein the timestamp and the further timestamp respectively comprise an indication of a length of the timestamp and the further timestamp.

13. The method according to claim 9, and comprising:
receiving at respective times subsequent to the receipt time respective further data frames comprising further error checksums;
generating respective further timestamps indicative of the respective subsequent times; and
incorporating the respective further timestamps into the respective further data frames in place of the further error checksums.

14. Apparatus, comprising:
a processor which is configured to receive, at a first time of receipt, a first data frame, and subsequent to the first time of receipt, sequentially to receive at respective second times second data frames; and
a timestamp engine which is configured to:
incorporate a first timestamp having a first length into the first data frame, the first timestamp being indicative of the first time of receipt, and
incorporate respective second timestamps having second lengths shorter than the first length into the second data frames, the respective second timestamps being indicative of respective increments in time from the first time of receipt.

15. The apparatus according to claim 14, wherein the first data frame received and the second data frames received comply with an Ethernet protocol.

16. The apparatus according to claim 14, wherein the processor is configured to receive, subsequent to the respective second times, a third data frame at a third time of receipt, and wherein the timestamp engine is configured to incorporate a third timestamp having the first length into the third data frame, the third timestamp being indicative of the third time of receipt.

17. The apparatus according to claim 16, wherein receiving the third data frame is in response to a counter of the respective increments overflowing.

18. The apparatus according to claim 14, wherein the first timestamp and the second timestamps comprise an indication of one of the first length and the second length.

19. The apparatus according to claim 14, wherein the first length is 9 bytes, and wherein the second lengths are 5 bytes.

20. The apparatus according to claim 14, wherein incorporating the first timestamp comprises appending the first timestamp to a first payload of the first data frame, and wherein incorporating the respective second timestamps comprises appending the second timestamps to respective second payloads of the second data frames.

21. The apparatus according to claim 14, wherein the first data frame comprises a first error checksum, and wherein incorporating the first timestamp comprises replacing the first error checksum by the first timestamp, and wherein the second data frames comprise respective second error checksums, and wherein incorporating the respective second timestamps comprises replacing the second error checksums by the respective second timestamps.
